(19) United States
(12) Patent Application Publication
(10) Pub. No.: US 2018/0040061 A1
(43) Pub. Date: Feb. 8, 2018

(54) COMPUTATIONALLY IMPLEMENTED METHOD FOR SAFE BANKING RELATED TRANSACTIONS

(71) Applicant: ARVEL OBRIEN, COLUMBIA, TN (US)

(72) Inventor: ARVEL OBRIEN, COLUMBIA, TN (US)

(21) Appl. No.: 15/229,131

(22) Filed: Aug. 5, 2016

(51) Int. Cl. G06Q 40/02

(52) U.S. Cl. CPC G06Q 40/02

(57) ABSTRACT

The present invention relates to a computationally implemented method on an article of manufacture enabling the user to transfer at least one non-payment banking related transaction from at least a first bank to at least a second bank. In the present invention, in order to avoid the hassles of filling out multiple forms and having to visit both banks when switching at least one non-payment banking related transaction and associated non-payment banking related transaction from at least a first bank to at least a second bank, the present computationally implemented method enables the user to simply enter some identifying information and have all the records of at least one non-payment banking related transaction changed automatically.

### FIELD OF THE INVENTION

The present invention relates to a computationally implemented method on an article of manufacture enabling the user to transfer at least one non-payment banking related transaction from at least a first bank to at least a second bank.

### BACKGROUND OF THE INVENTION

Today, many of us enjoy the convenience of handling our banking needs using our computers, smart phones or tablets. Now days writing checks for any banking related transaction is not a smart the smartest way to do things. In today's world someone conducting a banking related transaction is simply directed to his/her bank account via a secured gate way from where he/she is allowed to make payment for his/her banking institution. Herein, we may not even need to make deposits when incoming funds from various sources are transferred automatically. Also, instead of writing checks for banking related transactions, we are enabled to transfer money from our account to another's account wirelessly. This makes handling our finances convenient and secure but only if we are doing such transaction in the same bank and do not decide to shift from one bank to another.

When we move to a new town or find better service at a new bank, it take two, three, or more months and frequent visits to the banks in order to transfer all automatic payments and deposits. We have to maintain a balance in the first bank to cover payments until the automatic payments is established at the new bank, and have to monitor the old and new accounts carefully to be sure automatic deposits are done correctly.

Therefore, there remains a need to overcome above mentioned problems and our invention resolves this entire problem.

### SUMMARY OF THE INVENTION

The main objective of the present invention is to overcome the limitations of the prior arts by providing a computationally implemented method on an article of manufacture enabling the user to transfer at least one non-payment banking related transaction from at least a first bank account to at least a second bank account.

The present invention relates to a computationally implemented method on an article of manufacture enabling the user to transfer at least one non-payment banking related transaction and at least one associated non-payment banking related transaction from at least first bank account to at least a second bank account. In the present invention, for avoiding the hassles of filling out multiple forms and having to visit both banks when switching the account from at least the first bank to at least a second bank. The present computationally implemented method enables the user to simply enter some identifying information and have all the records of at least one non-payment banking related transaction changed automatically. Herein, the user is also allowed to choose a default language for the computationally implemented method so that the user is enabled to continue the computationally implemented method in a language understood by his/her easily. The user is also enabled to customize some of the details or select the advanced options to specify which non-payment banking related transaction is to be transferred from at least first bank to at least second bank. The non-payment banking related transaction includes but is not limited to a savings account, current account or salary account and at least one associated non-payment banking related transaction includes the associated loans, reoccurring deposits, provident funds and many more, but the scope of the invention is not limited to only this. Once the selection of the non-payment banking related transaction for at a least first bank and at least a second bank is done then the computationally implemented method is directed to a computing module wherein, the computing module enables computation of at least a first bank and at least a second bank and further enables transferring of at least one non-payment banking related transaction from at least a first bank to at least a second bank and further enables sending an acknowledgement receipt to at a least first bank, at least a second bank and at least one user in order to intimate to them that the transaction has been successfully conducted.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the flow chart which is also the preferred embodiment of the given invention according to an embodiment of the invention.

### DETAIL DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless, defined otherwise all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

In the present invention at least a first bank is in reference to the bank from where the user is willing transferring his/her account from, at least a second bank is in reference to the bank where the user is willing transferring his/her account to, article of manufacture is in reference to any smart device on which this computationally implemented method runs.

Moreover, the computationally implemented method on an article of manufacture enables the user to transfer at least one non-payment banking related transaction and at least one associated non-payment banking related transaction from at least a first bank to at least a second bank. In the present invention, in order to avoid the hassles of filling out multiple forms and having to visit both banks when switching at least one non-payment banking related transaction and associated non-payment banking related transaction from at a least first bank to at least a second bank. The present computationally implemented method enables the user to simply enter some identifying information and have all of the records of at least one non-payment banking related transaction changed automatically. They would also choose a default language for the computationally implemented method to use and choose the option to transfer all automatic non-payment banking related transactions. The user is also enabled to customize some of the details or select the advanced options to specify which non-payment banking related transaction should be transferred from at least a first bank to at least a second bank wherein at least one non-payment banking related transaction including savings account, current account and salary account and at least one associated non-payment banking related transaction includes the associated loans, reoccurring deposits, provident funds and many more but the scope of the invention is not limited to only this. Once the selection of the non-payment banking related transaction is done the computing module comes into play wherein the computing module enables computation of the given bank and the user details and helps in transferring the given at least one non-payment banking related transaction from at least a first bank to at a least second bank, and further enables sending an acknowledgement so that the user, at least a first bank and at least a second bank comes to know that the transaction has been successfully transferred.

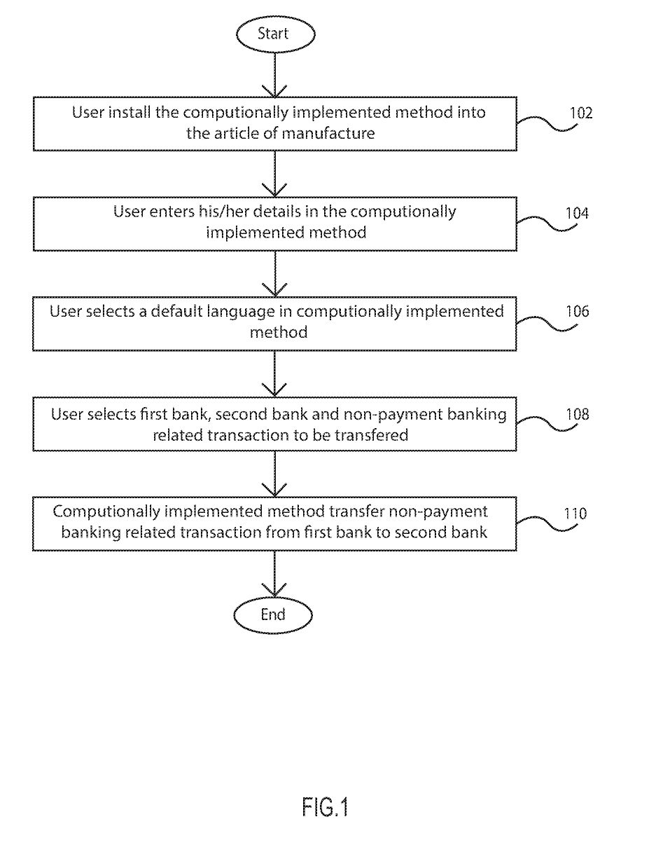

FIG. 1 illustrates the flow chart [100] of the given invention which is also the preferred embodiment of the given invention.

Step. 102 of FIG. 1 illustrates process of installation of the computationally implemented method on an article of manufacture which enables a home screen to appear on an article of manufacture of the user and the user then in turn tap on the start button to start the installation of the computationally implemented method on an article of manufacture wherein, the installation takes place via various stores available, for example Google play store and iTunes, the most popular application store in the primary market and for the android version of the computationally implemented method, there are several new stores that are present in the current cyber world market such as Apply, Samsung Apps, F-droid, Slide ME, Get Jar and Amazon. After the user installs the computationally implemented method on his/her article of manufacture the user gets started for the further process of transferring at least one banking related transaction from a plurality of banking related transaction from at least a first bank to at least a second bank.

Step. 104 of FIG. 1 illustrates the process of identification of the user to access the computationally implemented method in order to transfer at least one non-payment banking related transaction from at least a first bank to at least a second bank. Herein, an account transfer main info screen appears, enabling identification of the user for the computationally implemented method on an article of manufacture wherein, the identification of the user for the computationally implemented method is done in two ways, that is either manually or electronically, but the scope of the invention is not limited to only this. The manual identification of the user includes the use of the biometric sensors wherein these biometric sensors are the ubiquitous technology like a microphone for voice capture or a high definition camera for facial recognition. These biometric sensors are also specially designed units made to scan the vein patterns under your skin or the unique features in your fingertip wherein the use of biometric sensors for the identification of the user makes the use of this computationally implemented method highly safe and reliable. The second way of identification of the user includes the use of the electronic input wherein the electronic input for the identification of the user is also done in different ways including electronic signature of the user, entering the various account details via the user like his/her account number, name or other bank details. This identification unit also enables the user to create a login id and a pass code for accessing the various features provided via the computationally implemented method. This login id and pass code includes the various type manual or electronic inputs provided by the computationally implemented method.

Step. 106 of FIG. 1 illustrates the process of selection of the default language for the computationally implemented method. Herein, an option screen appears that allows the user to select a default language and the user selects a default language for the computationally implemented method. Herein, the user is enabled selecting any language convenient to him/her according to his/her understanding providing a convenient method of transfer of at least one non-payment banking related transaction and the scope of the invention is not limited to only this.

Step. 108 of FIG. 1 illustrates the selection process of at least first bank, at least second bank, and at least one non-payment banking related transaction. This selection process enabling selection of at least a first bank from where the user wants to shift at least one of his non-payment banking related transactions and selection of at least a second bank wherein the user is willing to shift his at least one of the non-payment banking related transaction. The selection module not only provides selection of at least a first bank and at a least second bank but is also enables selecting at least one non-payment banking related transaction from the plurality of banking related transaction. At least one of the non-payments banking related transactions includes the whole account of the user which the user willingly transfers from at least a first bank to at least a second bank at the time the user of this invention is moving from one area to another, from one city to another or from one country to another. The user is also enabled to use this computationally implemented method when he/she is getting any profit in shifting his/her at least one non-payment banking related transaction from at least a first bank to at least a second bank.

Step. 110 of FIG. 1 illustrates transfer of the at least one non-payment banking related transaction from at least a first bank to at least a second bank wherein this transfer enables the completion of at least one non-payment banking related transaction to be transferred from at least a first bank to at least a second bank in accordance to the selection been made via user and this is further accompanied via an acknowledgement receipt This acknowledgement enables the user willingly shifting from at least a first bank to at least a second bank to know the status of the transfer. This acknowledgement is not only given to the user but also to the first bank and the second banks indicating that all the non-payment banking related transactions have been successfully transferred and the user is now free to access the at least one non-payment banking related transaction in at least a second bank.

In another embodiment of the given invention of the computationally implemented method for an article of manufacture, the computationally implemented method is not only limited to transferring at least one banking related transaction from at least a first bank to at least a second bank but also includes the transfer of at least one associated banking related transaction from at least a first bank to at least a second bank wherein at least one associated banking related transaction includes the associated reoccurring deposits, provident funds and many more but the scope of the invention is not limited to only this. The user here is also enabled to customize which associated non-payment banking related transactions he/she wills to transfer from all the associated non-payment banking related transactions, from at least a first bank to at least a second bank along with at least one non-payment banking related transaction. Herein, at least one user need not transfer all of at least one associated non-payment banking related transaction from at least a first bank to at least a second bank and at least one user is allowed to keep some of his at least one associated non-payment banking related transaction in at least a first bank. Also, there exists a process of auto linking at least one associated non-payment banking related transaction in at least a first bank with at least one non-payment banking related transaction in at least a second bank that is if in the case that at least one user enables transfer of at least one non-payment banking related transaction from at least a first bank to at least a second bank but is not willing to transfer his/her at least one associated non-payment banking related transaction from at least a first bank to at least a second bank, then at least one user is provided with an option to auto link his/her at least one associated non-payment banking related transaction present in at least a first bank with at least one non-payment banking related transaction present in at least a second bank.

In another embodiment of the present invention of the computationally implemented method comprises an identification module wherein, the identification module enables identification of the user for the computationally implemented method on the article of manufacture. This module enables identification of the user in two ways that is either via manual input or via electronic input wherein the manual input for the identification of the user makes use of the biometric sensor. This biometric sensor is the ubiquitous technology like a microphone for voice capture or a high definition camera for facial recognition. These biometric sensors are also specially designed units made to scan the vein patterns under the user's skin or the unique features in the user's fingertip wherein the use of biometric sensors for the identification of the user wherein this technology makes the use of this computationally implemented method highly secured for anyones use. Further, the identification of the user is also enabled via electronic input wherein the electronic input involves electronic signature of the user or any further bank details like the user's bank account number or his name or his/her IFSC number wherein the scope of the invention is not limited to only this. Once, the user has been identified via an identification module the user is enabled further into the computationally implemented method and is directed to the selection module wherein the selection module is enabled to provide various selection options from where the user has to make further selections. The selection module provides the user to select at least a first bank from the plurality of the banks where the user is willing transferring his/her at least one non-payment transaction and enables selection of at least a second bank from the plurality of the banks where the user wants to transfer his/her at least one non-payment transaction. The selection module not only enables selection of at least one first and at least a second bank but also enables selection of at least one non-payment banking related transaction and at least one associated non-payment banking related transaction to be transferred from at least a first bank to at least a second bank. Herein, in the present invention once the selection of the banks and the transaction has been done then the user selected information is directed to the computing module wherein the computing module enables sending a simultaneous transfer request to both at least a first bank and to at least a second bank, if the processor grants the transfer request of transferring at least one non-payment banking related transaction and at least one associated non-payment banking related transaction, then the process is directed further and the transfer of at least one non-payment banking related transaction along with customized at least one non-payment banking related transaction from at least a first bank to at least a second bank. The computing module is also enabled to send an acknowledgement receipt of transfer to the user, from at least a first bank and to at least a second bank indicating that the transfer of the at least one non-payment banking related transaction was successfully completed and the user is enabled to access his/her at least one non-payment banking related transaction in another at least a second bank. This process is less time consuming and does not involve months or weeks to process the user's request of at least one non-payment banking related transaction to be transferred.

While the invention has been described in detail with specific reference to preferred embodiments thereof, it is understood that variations and modifications thereof may be made without departing from the true spirit and scope of the invention.

What is claimed is:

1. A computationally implemented method on an article of manufacture, wherein the computationally implemented method enables at least one non-payment banking related transaction from at least a first bank to at least a second bank, comprises:
a. a selection module, wherein the selection module enables selection of at least one non-payment banking related transaction, from plurality of non-payment banking related transactions, associated with at least a first bank and the selection module further enables selection of at least a second bank from the plurality of banks wherein at least a second bank is enabled to receive at least one non-payment banking related transaction, associated with at least a first bank, from at least a first bank;
b. a computing module enables:
i. receiving the information related to the selected at least one non-payment banking related transaction, associated with at least a first bank, and the selected at least a second bank, wherein the computing module seeks a second permission from at least a second bank to initiate the selected at least one non-payment banking related transaction, associated with at least a first bank, after receiving approval of a first permission from at least a first bank related to the selected at least one non-payment banking related transaction, associated with at least a first bank;
ii. initiating the selected at least one non-payment banking related transaction, associated with at least a first bank, from at least a first bank to at least a second bank upon receiving the approval of the second permission from at least a second bank; and
iii. transmitting an acknowledgement signal to at least one of the first bank, at least a second bank and the computationally implemented method after successful transmission of the selected at least one non-payment baking related transaction, associated with at least a first bank, to the selected at least a second bank.

2. The computationally implemented method in claim 1; wherein the selection module also enables selection of at least one associated non-payment banking related transaction from at least one non-payment banking related transaction of at least a first bank.

3. The computationally implemented method in claim 1; wherein the computationally implemented method also enables direct transfer of at least one associated non-payment banking related transaction with at least one non-payment banking related transaction of at least a first bank to at least a second bank.

4. The computationally implemented method in claim 1; wherein the computationally implemented method enables auto crediting of at least one associated non-payment banking related transaction to at least one non-payment banking related transaction of at least a first bank from a deposit done in at least a second bank.

5. The computationally implemented method in claim 1; wherein the computationally implemented method also comprises an identification module wherein the identification module enables identification of the user via manual input.

6. The computationally implemented method in claim 1; wherein the computationally implemented method also comprises an identification module wherein the identification module enables identification of the user via electronic input.

7. A computationally implemented method on an article of manufacture, wherein the computationally implemented method enables at least one non-payment banking related transaction from at least first bank to at least a second bank, comprises:
a. a selection module, wherein the selection module enables selection of at least one non-payment banking related transaction and at least one associated non-payment banking related transaction, from plurality of banking related transactions, associated with at least a first bank and the selection module further enables selection of at least a second bank from the plurality of banks wherein at least a second bank is enabled to receive at least one non-payment banking related transaction, associated with at least a first bank, from at least a first bank;
b. a computing module enables:
i. receiving the information related to the selected at least one non-payment banking related transaction, associated with at least a first bank, and the selected at least a second bank, wherein the computing module seeks a second permission from at least a second bank to initiate the selected at least one non-payment banking related transaction, associated with at least a first bank, after receiving approval of a first permission from at least a first bank related to the selected at least one non-payment banking related transaction, associated with at least a first bank;
ii. initiating the selected at least one non-payment banking related transaction, associated with at least a first bank, from at least a first bank to at least a second bank upon receiving the approval of the second permission from at least a second bank; and
iii. transmitting an acknowledgement signal to at least one of the first bank, at least a second bank and the computationally implemented method after successful transmission of the selected at least one non-payment baking related transaction, associated with at least a first bank, to the selected at least a second bank.

8. The computationally implemented method in claim 7; wherein the selection module also enables selection of at least one associated non-payment banking related transaction from at least one banking related transaction of at least a first bank.

9. The computationally implemented method in claim 7; wherein the computationally implemented method also enables direct transfer of at least one associated non-payment banking related transaction with at least one non-payment banking related transaction of at least a first bank to at least a second bank.

10. The computationally implemented method in claim 7; wherein the computationally implemented method enables auto crediting of at least one associated non-payment banking related transaction to at least one non-payment banking related transaction of at least first bank from a deposit done in at least a second bank.

11. The computationally implemented method in claim 7; wherein the computationally implemented method also comprises an identification module wherein the identification module enables identification of the user via manual input.

12. The computationally implemented method in claim 7; wherein the computationally implemented method also comprises an identification module wherein the identification module enables identification of the user via electronic input.
